(19) United States
(12) Patent Application Publication
(10) Pub. No.: US 2023/0238738 A1
(43) Pub. Date: Jul. 27, 2023

(54) BARCODE SCANNER FOR SMART PHONE BY MAGNETIC CONNECTION

(71) Applicant: MARSON TECHNOLOGY CO., LTD., New Taipei City (TW)

(72) Inventor: KUO-SHEN LIU, New Taipei City (TW)

(21) Appl. No.: 17/580,656

(22) Filed: Jan. 21, 2022

(51) Int. Cl. H01R 13/62; H01R 33/94; H01R 31/06; G06K 7/14; H04M 1/02

(52) U.S. Cl. CPC H01R 13/6205; H01R 33/94; H01R 31/06; G06K 7/1413; H04M 1/0254; H01R 2201/06

(57) ABSTRACT

A barcode scanner magnetically attachable to a smart phone includes a circuitry adaptor and a barcode-scanning device. The circuitry adaptor is plugged into a USB connector of the smart phone. The barcode-scanning device is magnetically and detachably connected to the circuitry adaptor, so that electricity and signals from the smart phone are transmitted to the barcode-scanning device, and barcode signals picked up by the barcode-scanning device are transmitted to the smart phone. When the barcode-scanning device undergoes external impact, the circuitry adaptor and the barcode-scanning device are detached from each other without damaging the USB connectors.

### BACKGROUND OF THE INVENTION

### (a) Technical Field of the Invention

The present invention is generally related to barcode scanning, and more particular to a barcode scanner fitted on a smart phone by magnetic connection.

### (b) Description of the Prior Art

Mobile computers are widely popular for warehouse management, transportation logistics, smart retailing, smart medical, smart manufacturing, etc., due to their small form factor easier to carry. Mobile computers generally have two types: one having mechanical keyboard, as shown in FIG. 1, such as the one disclosed by U.S. Pat. No. D340,034 titled “Handheld computer with built-in bar code scanner,” and one providing virtual keyboard, as shown in FIG. 2, such as the one disclosed by U.S. Pat. No. 8,456,428 titled “User interface for mobile computing device.” Both types of mobile computers are equipped with a screen yet the second type is developed later and has a larger screen. The second type seems to the main stream lately as, if one searches Google, the second one dominates the search result. Yet, as the virtual keyboard is more difficult to use, most of this type mobile computers have a separate barcode scanner as a major means of data input.

On the other hand, smart phones these days are so popular that almost every person has at least a smart phone. The world's number of smart phones probably is thousands of times more than mobile computers. A smart phone is also more powerful and versatile than a mobile computer. By installing an App for reading barcodes, the smart phone would be just like the above-mentioned second type of mobile computer. However, the smart-phone-based barcode scanning has the following disadvantages:

1. The smart phone's camera has more pixels and, as such, the decoding speed is slower.

2. The smart phone's camera uses color CMOS sensor whereas barcode is black-and-white and, as such, the decoding speed is slower.

3. The smart phone's camera has a greater depth of field and, to read a barcode, the camera has to be focused first. On the other hand, an ordinary barcode scanner usually uses lens of fixed focal length and, therefore, is faster in reading and decoding barcode.

4. The smart phone's camera usually adopts a rolling shutter CMOS sensor whereas an ordinary barcode scanner uses a global shutter CMOS sensor, which requires a shorter period of exposure and has a greater motion tolerance.

Due to the above shortcomings, smart phones are rarely used for serious barcode scanning.

To overcome these shortcomings of smart phone for barcode scanning, Taiwan Patent No. M486100 teaches a barcode-scanning system integrating a smart phone and a barcode scanner. As shown in FIGS. 3 and 4 (also M486100's FIGS. 1 and 2), a barcode-scanning system 10 includes a smart phone 101 and a barcode scanner 102. The barcode scanner 102 includes a main member 1021 with a USB (universal serial bus) male connector 1022 on a back side. The smart phone 101 includes a screen 1011 and a USB female connector 1012. The USB male connector 1022 is plugged into the USB female connector 1012. The smart phone 101 transmits electricity and signals to the barcode scanner 102 through the USB connection. The barcode scanner 102 transmits the barcode signals to the smart phone 101 also through the USB connection. The barcode decoding software may be stored in the barcode scanner 102 or in the smart phone 101. The barcode-scanning system 10 has all the advantages offered by the smart phone. However, a major drawback is that, when an external force affects the barcode scanner 102, the USB male connector 1022 is often snapped, or the USB female connector 1012 is damaged.

### SUMMARY OF THE INVENTION

A major objective of the present invention is to provide a barcode scanner that is magnetically attached to a smart phone so that, under external impact, the USB connectors of the barcode scanner and the smart phone are not damaged.

The barcode scanner includes a circuitry adaptor and a barcode-scanning device. The circuitry adaptor is plugged into a USB connector of the smart phone. The barcode-scanning device is magnetically and detachably connected to the circuitry adaptor, so that electricity and signals from the smart phone are transmitted to the barcode-scanning device, and barcode signals picked up by the barcode-scanning device are transmitted to the smart phone. When the barcode-scanning device undergoes external impact, the circuitry adaptor and the barcode-scanning device are detached from each other without damaging the USB connectors.

The circuitry adaptor further includes a magnet and a USB male connector on a front side for connecting the USB female connector of the smart phone. The USB male connector is electrically connected to the contacts.

The barcode-scanning device has a magnetic part on a front side where the pogo pins are configured. The pogo pins has their tips extruding out of a front side of the magnetic part; and the pogo pins are electrically connected to a circuit of the barcode-scanning device.

The magnetic part of the barcode-scanning device includes a magnet.

The magnet of the circuitry adaptor has a polarity opposite to that of the magnetic part of the barcode-scanning device.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a conventional mobile computer.

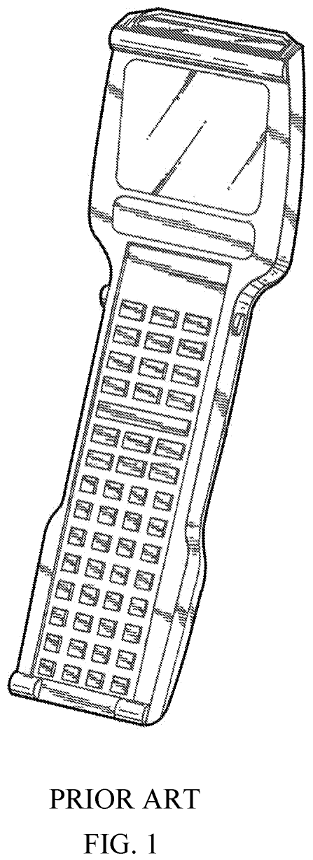

FIG. 2 is a perspective diagram showing another conventional mobile computer.

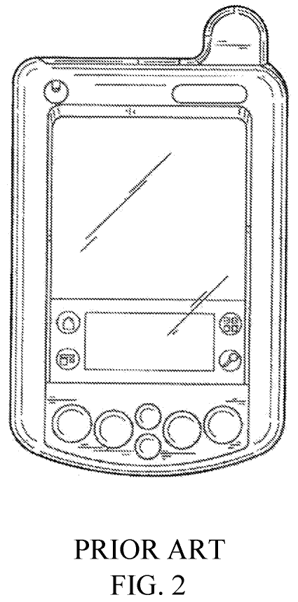

FIG. 3 is a perspective diagram from Taiwan Patent No. M486100.

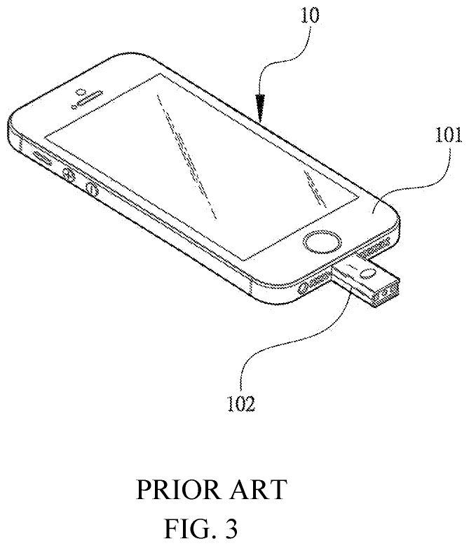

FIG. 4 is another perspective diagram from Taiwan Patent No. M486100.

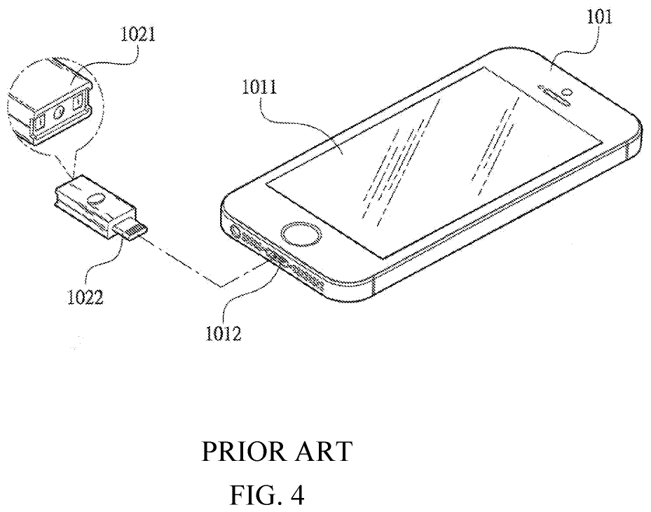

FIG. 5 is a perspective breakdown diagram showing a barcode scanner according to a first embodiment of the present invention.

FIG. 6 is a perspective diagram showing the barcode scanner of FIG. 5.

FIG. 7 is a schematic top view diagram showing the barcode scanner of FIG. 5.

FIG. 8 is a perspective breakdown diagram showing how a smart phone is charged through the circuitry adaptor of FIG. 5.

FIG. 9 is a perspective breakdown diagram showing a barcode scanner according to a second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

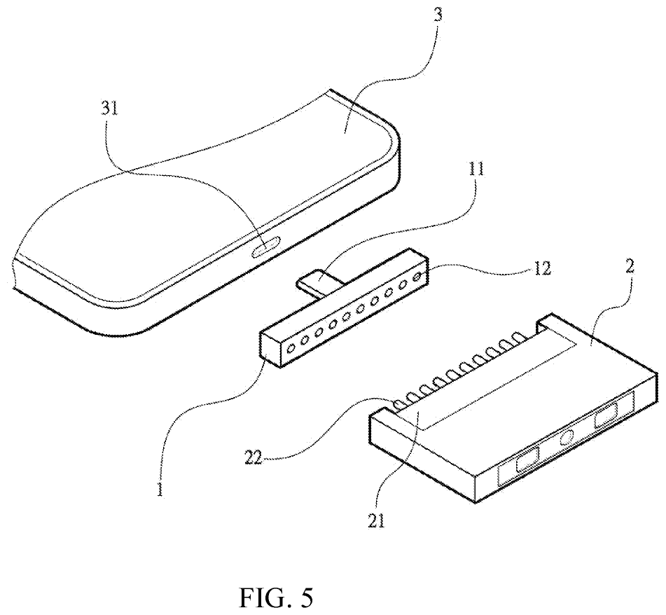

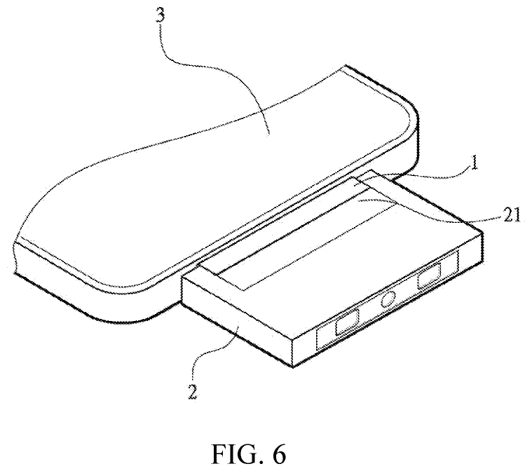

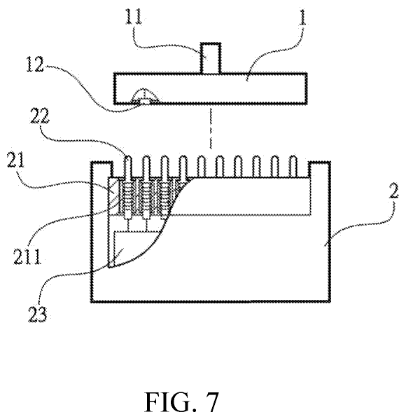

As shown in FIG. 5, FIG. 6, and FIG. 7, a barcode scanner according to a first embodiment of the present invention includes a circuitry adaptor 1 and a barcode-scanning device 2. The circuitry adaptor 1 includes a USB male connector 11, and a number of contacts 12 configured on a side of the circuitry adaptor 1 opposite to the USB male connector 11. The USB male connector 11 is electrically connected to the contacts 12. In the present embodiment, the circuitry adaptor 1 includes a magnet.

The barcode-scanning device 2 includes a magnetic part 21 on a front end, and the magnetic part 21 has a number of chambers 211 respectively housing an equal number of pogo pins 22 where the pogo pins 22 have their tips extruding out of the magnetic part 21's front side, and the pogo pins 22 are electrically connected to a circuit 23 inside the barcode-scanning device 2. The magnetic part 21 is magnetized, and has a polarity opposite to that of the magnet inside the circuitry adaptor 1. The two therefore attract each other.

To use the barcode scanner, the USB male connector 11 of the circuitry adaptor 1 is first plugged into a USB female connector 31 of a smart phone 3. Then, the barcode-scanning device 2 is placed adjacent to the circuitry adaptor 1, where the two are joined together by the mutual magnetic attraction between the circuitry adaptor 1 and the magnetic part 21. The pogo pins 22 as such are contacted with and conducted to the contacts 12. In addition, due to the elasticity of pogo pins 22, they are pressed against the contacts 12 by their elasticity, thereby securing the electrical connection. Electricity and signals from the smart phone 3 are transmitted to the barcode-scanning device 2 through the pogo pins 22, while barcode signals picked up by the barcode-scanning device 2 are transmitted to the smart phone 3 also via the pogo pins 22. The decoding software may reside in the barcode-scanning device 2 or in the smart phone 3. When the barcode-scanning device 2 undergoes external impact, circuitry adaptor 1 and the magnetic part 21 are detached, without damaging the USB male connector 11 of the circuitry adaptor 1 or the USB female connector 31 of the smart phone 3. By placing the barcode-scanning device 2 again around the circuitry adaptor 1, the barcode-scanning device 2 restores its connection with the circuitry adaptor 1 automatically, resolving the problem suffered by prior arts such as the one discloses in Taiwan Patent No. M486100.

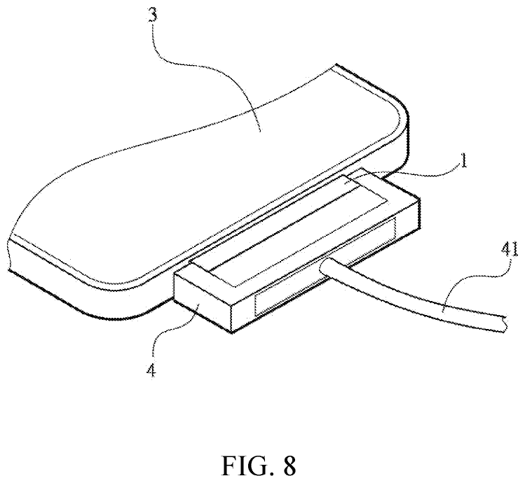

As shown in FIG. 8, to charge the smart phone 3 equipped with the circuitry adaptor 1, a charging adaptor 4 is magnetically attached to the circuitry adaptor 1 and a cable 41 of the charging adaptor 4 is connected to a power source (not shown) so as to charge the smart phone 3. Of course, it is also possible to remove the circuitry adaptor 1 from the smart phone 3 and the smart phone 3 may be charge through conventional means.

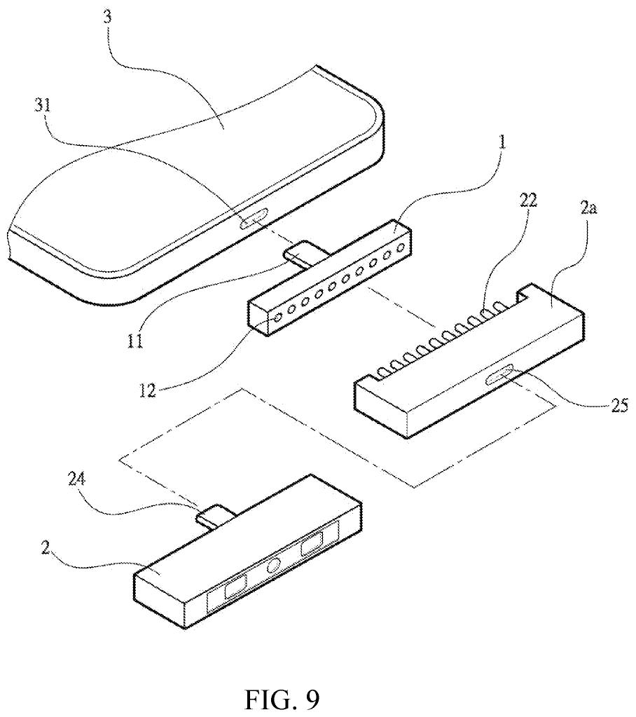

As shown in FIG. 9, a barcode scanner according to a second embodiment of the present invention further includes a second circuitry adaptor 2a. The second circuitry adaptor 2a includes the pogo pins 22 as in the previous embodiment and has a USB female connector 25 on a back side while the barcode-scanning device 2 of the present embodiment has a USB male connector 24 on a front side. The barcode-scanning device 2 and the second circuitry adaptor 2a are coupled together by plugging the USB male connector 24 into the USB female connector 25, thereby forming an integrated barcode-scanning device 2 as shown in FIG. 5. The advantage of the present embodiment is that it is easier to manufacture, but the disadvantage is that more material is involved.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A barcode scanner for a smart phone by magnetic connection, comprising a circuitry adaptor and a barcode-scanning device, wherein
the circuitry adaptor comprises a USB male connector, and on opposite side, comprises a magnet with a plurality of contacts which are electrically connected to its USB male connector;
the barcode-scanning device comprises a plurality of pogo pins for establishing electrical connection with the contacts, and is magnetically and detachably attached to the circuitry adaptor; and
electricity and signals from the smart phone are transmitted to the barcode-scanning device, and barcode signals picked up by the barcode-scanning device are transmitted to the smart phone, both through the pogo pins and contacts.

2. The barcode scanner according to claim 1, wherein the USB male connector of circuitry adaptor is for connecting to the USB female connector of the smart phone; and the barcode-scanning device has a magnetic part for magnetically and detachably attached to the magnet of circuitry adaptor.

3. The barcode scanner according to claim 1, wherein the pogo pins has their tips extruding out of a front side of the magnetic part; and the pogo pins are electrically connected to a circuit of the barcode-scanning device.

4. The barcode scanner according to claim 2, wherein a front part of the barcode-scanning device is separated into an independent second circuitry adaptor; the second circuitry adaptor has a USB female connector on a back side; and the barcode-scanning device has a USB male connector for plugging into the USB female connector of the second circuitry adaptor, thereby forming the barcode scanner.

5. The barcode scanner according to claim 1, wherein a barcode decoding software is stored in the barcode-scanning device or in the smart phone.

6. The barcode scanner according to claim 2, wherein the magnet of the circuitry adaptor has a polarity opposite to that of the magnetic part of the barcode-scanning device.
